(19) United States
(12) Patent Application Publication
(10) Pub. No.: US 2010/0229841 A1
(43) Pub. Date: Sep. 16, 2010

(54) NITROGEN-ENRICHED GAS SUPPLYING DEVICE FOR INTERNAL COMBUSTION ENGINE

(75) Inventors: Toshiaki Nakayama, Nishikamo-gun (JP); Hitoshi Tanaka, Nagoya-city (JP); Katsuhiko Nakabayashi, Handa-city (JP); Yusaku Suzuki, Toyota-city (JP); Osamu Sato, Takahama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/723,145

(22) Filed: Mar. 12, 2010

(30) Foreign Application Priority Data
Mar. 13, 2009 (JP) 2009-61814

(51) Int. Cl. F02M 25/07; F02D 23/00; F02B 33/44; F01N 13/08; F01N 3/02

(52) U.S. Cl. 123/568.11; 60/602; 60/605.2; 60/324; 60/311

(57) ABSTRACT

A nitrogen-enriched gas supplying device includes a bypass passage and a gas separating membrane, so as to supply nitrogen-enriched gas to an internal combustion engine. The bypass passage introduces a part of exhaust gas from an exhaust passage of the internal combustion engine into an intake passage of the internal combustion engine. The gas separating membrane is arranged in the bypass passage. The gas separating membrane is configured to separate carbon dioxide from exhaust gas introduced into the bypass passage.

### CROSS REFERENCE TO RELATED APPLICATION

This application is based on Japanese Patent Application No. 2009-61814 filed on Mar. 13, 2009, the disclosure of which is incorporated herein by reference in its entirety.

### BACKGROUND OF THE INVENTION

1. Field of the Invention

The present invention relates to a nitrogen-enriched gas supplying device to supply nitrogen-enriched gas to a combustion chamber of an internal combustion engine of a vehicle.

2. Description of Related Art

JP-A-2004-190570 discloses a device to supply nitrogen-enriched air to an internal combustion engine, so as to reduce nitrogen oxides (NOx) contained in exhaust gas and to increase fuel efficiency. The device supplies nitrogen-enriched air by using a gas separating membrane to remove a part of oxygen from air.

However, a separation efficiency of the device is low, because a separation ratio of oxygen to nitrogen is low. Therefore, a complicated device may be further needed for supplying pressurized air, or a size of the gas separating membrane may be made larger, so as to increase the separation efficiency.

### SUMMARY OF THE INVENTION

In view of the foregoing and other problems, it is an object of the present invention to provide a nitrogen-enriched gas supplying device.

According to an example of the present invention, a nitrogen-enriched gas supplying device for supplying nitrogen-enriched gas to an internal combustion engine includes a bypass passage and a gas separating membrane. The bypass passage introduces a part of exhaust gas from an exhaust passage of the engine into an intake passage of the engine. The gas separating membrane is arranged in the bypass passage. The gas separating membrane is configured to separate carbon dioxide from exhaust gas introduced into the bypass passage.

Accordingly, nitrogen-enriched gas can be efficiently supplied to a combustion chamber of an internal combustion engine.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram illustrating a nitrogen-enriched gas supplying device according to a first embodiment;

FIG. 2 is a schematic diagram illustrating a nitrogen-enriched gas supplying device according to a second embodiment;

FIG. 3 is an enlarged view illustrating a nitrogen-enriched gas supplying device according to a third embodiment;

FIG. 4A is an enlarged view illustrating a nitrogen-enriched gas supplying device according to a fourth embodiment, and FIG. 4B is a cross-sectional view illustrating the device of FIG. 4A;

FIG. 5 is an enlarged view illustrating a nitrogen-enriched gas supplying device according to a fifth embodiment;

FIG. 6 is a schematic diagram illustrating a nitrogen-enriched gas supplying device according to a sixth embodiment; and

FIG. 7 is a schematic diagram illustrating a nitrogen-enriched gas supplying device according to a seventh embodiment.

### DETAILED DESCRIPTION OF PREFERRED EMBODIMENT

### First Embodiment

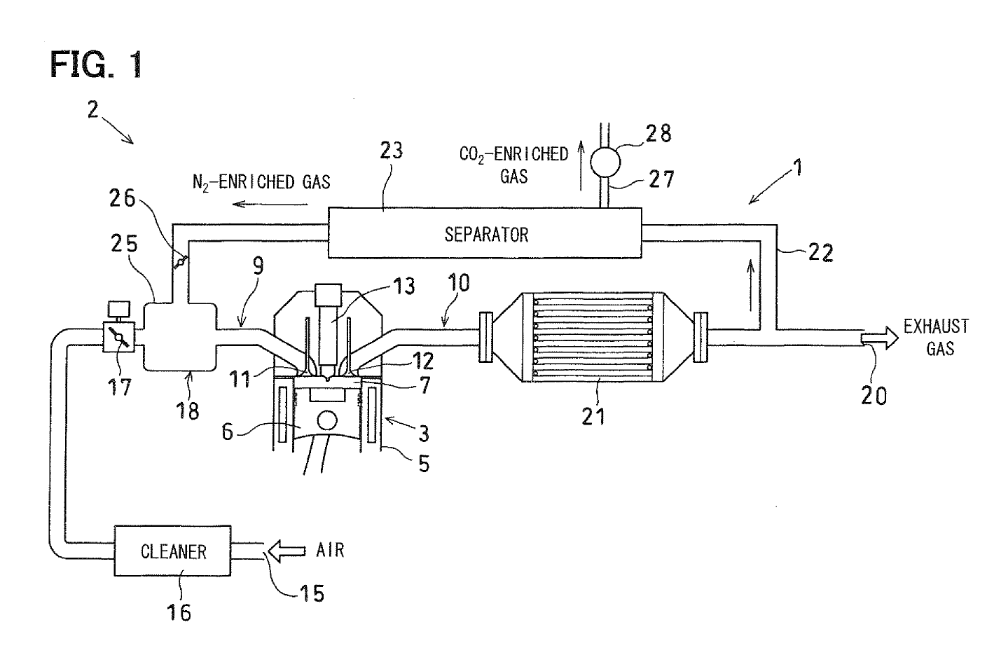

As shown in FIG. 1, an engine system 2 has a nitrogen-enriched gas supplying device 1. An internal combustion engine 3 of FIG. 1 is a gasoline direct-injection engine. Alternatively, the engine 3 may be a diesel engine.

The engine 3 has a cylinder 5 and a piston 6 sliding in the cylinder 5. An upper part of the cylinder 5 is defined as a combustion chamber 7. The engine 3 includes a plurality of the cylinders 5.

An air intake passage 9 and an air exhaust passage 10 are connected to the combustion chamber 7. The intake passage 9 introduces air into the chamber 7, and the exhaust passage 10 sends exhaust gas from the chamber 7 to outside. An air intake valve 11 is arranged between the chamber 7 and the intake passage 9 so as to open or close the intake passage 9. An exhaust gas valve 12 is arranged between the chamber 7 and the exhaust passage 10 so as to open or close the exhaust passage 10.

The engine 3 has a fuel injection valve 13 to inject fuel into the combustion chamber 7, and an ignition (not shown) to ignite air-fuel mixture in the combustion chamber 7.

An air intake side of the engine 3 has the intake passage 9. A most upstream side of the intake passage 9 corresponds to an air intake port 15, and a most downstream side of the intake passage 9 corresponds to the combustion chamber 7. An air cleaner 16, a throttle valve 17, and an intake manifold 18 are arranged in the intake passage 9 from the upstream side in this order. Air flowing in the intake passage 9 is filtered by the air cleaner 16. The throttle valve 17 opens or closes the intake passage 9. The intake manifold 18 distributes intake air into the cylinders 5.

An air exhaust side of the engine 3 has the exhaust passage 10. A most upstream side of the exhaust passage 10 corresponds to the combustion chamber 7, and a most downstream side of the exhaust passage 10 corresponds to an air exhaust port 20 open to outside. A catalyst 21 is arranged in the exhaust passage 10 so as to clean exhaust gas. A bypass passage 22 is connected to a downstream side of the catalyst 21.

The engine system 2 has the nitrogen-enriched gas supplying device 1 including the bypass passage 22 and a separator 23. The bypass passage 22 introduces a part of exhaust gas from the exhaust passage 10 to the intake passage 9. The separator 23 is arranged in the bypass passage 22, and separates carbon dioxide (CO₂) from exhaust gas flowing in the bypass passage 22.

An upstream side of the bypass passage 22 is connected to the downstream side of the catalyst 21 in the exhaust passage 10. A downstream side of the bypass passage 22 is connected to a surge tank 25 of the intake manifold 18 corresponding to the intake passage 9.

The separator 23 has a gas separating membrane made of hollow fibers, and exhaust gas is introduced into the separator 23 from the exhaust passage 10 after passing through the catalyst 21. A permeability of carbon dioxide is higher than that of nitrogen or oxygen, relative to the separator 23.

The separator 23 is able to separate the exhaust gas into CO₂-enriched gas rich in carbon dioxide and N₂-enriched gas rich in nitrogen. That is, the CO₂-enriched gas is permeated through the separator 23, and the N₂-enriched gas is not permeated through the separator 23. The N₂-enriched gas flows out of the separator 23, and is introduced into the combustion chamber 7 through the surge tank 25.

A valve 26 is arranged at an upstream side of the surge tank 25 in the bypass passage 22. An amount of the N₂-enriched gas returned to the intake passage 9 is controlled by the valve 26.

The nitrogen-enriched gas supplying device 1 further includes a vacuum pump 28 located in a pipe 27. The pipe 27 is connected to a permeation side of the separator 23. The vacuum pump 28 may correspond to a negative pressure generator.

The vacuum pump 28 generates a pressure difference corresponding to a driving force to separate gas introduced into the separator 23. When the permeation side of the separator 23 is depressurized by the vacuum pump 28, carbon dioxide is permeated through the membrane, such that the carbon dioxide can be separated from exhaust gas. The permeated CO₂-enriched gas is discharged outside, for example.

According to the first embodiment, the nitrogen-enriched gas supplying device 1 has the bypass passage 22 and the gas separating membrane. The bypass passage 22 introduces a part of exhaust gas from the exhaust passage 10 to the intake passage 9. The membrane is arranged in the bypass passage 22, and separates carbon dioxide from exhaust gas flowing in the bypass passage 22. The device 1 further includes the vacuum pump 28 to generate a pressure difference between a supply side and a permeable side of the membrane. The vacuum pump 28 is located on the permeation side of the membrane.

Therefore, carbon dioxide can be separated from exhaust gas by the membrane, and nitrogen-enriched air can be supplied to the combustion chamber 7 through the intake passage 9. The nitrogen-enriched air may correspond to nitrogen-enriched gas.

A separation ratio of carbon dioxide to nitrogen is larger than a separation ratio of oxygen to nitrogen. Therefore, carbon dioxide can be efficiently separated by using exhaust gas containing much carbon dioxide and less oxygen, even if a size of the membrane is small.

Thus, nitrogen-enriched gas can be efficiently supplied to the combustion chamber 7 in the engine system 2 having a small size.

Further, pumping loss can be reduced, and combustion efficiency can be raised, because a part of exhaust gas is recirculated from the exhaust passage 10 to the combustion chamber 7. Furthermore, mileage can be increased, because a specific heat ratio of the nitrogen-enriched gas is higher than that of exhaust gas containing carbon dioxide.

The pressure difference is generated by the vacuum pump 28 so as to generate a driving force of gas separation. The permeation side of the membrane is depressurized by the vacuum pump 28, such that carbon dioxide can be separated.

Thus, a size of the engine system 2 can be smaller, compared with a case in which the pressure difference is generated by a compressor, because a buffer tank is unnecessary in a case in which the pressure difference is generated by the vacuum pump 28.

### Second Embodiment

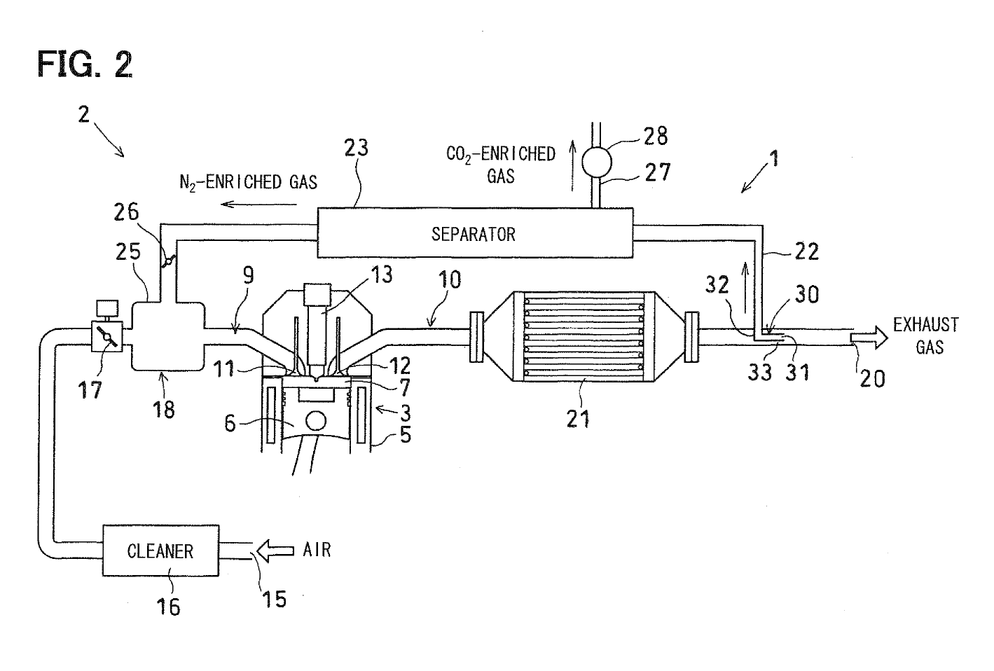

As shown in FIG. 2, a bypass passage 22 is connected to an exhaust passage 10 through a L-shaped communication tube 30, in a second embodiment. The tube 30 is inserted into the exhaust passage 10, and has an intake port 31 open toward a downstream side of the exhaust passage 10.

The tube 30 defines an upstream end of the bypass passage 22. The tube 30 has a perpendicular part 32 and a parallel part 33. The perpendicular part 32 extends in a direction approximately perpendicular to an extending direction of the exhaust passage 10. The parallel part 33 is formed by bending the perpendicular part 32 so as to extend in a direction approximately parallel to the extending direction of the exhaust passage 10. The intake port 31 is defined at an end of the parallel part 33.

Exhaust gas flowing through the exhaust passage 10 contains dust such as carbon. The dust is moved by a flow of exhaust gas in the exhaust passage 10 due to an inertia force.

According to the second embodiment, exhaust gas is drawn through the L-shaped tube 30 having the intake port 31 open to the downstream side of the exhaust passage 10. Therefore, dust can be restricted from being drawn into the tube 30, because dust is heavier than exhaust gas.

Thus, dust can be prevented from adhering onto a gas separating membrane of a separator 23, such that deterioration of the membrane can be restricted.

### Third Embodiment

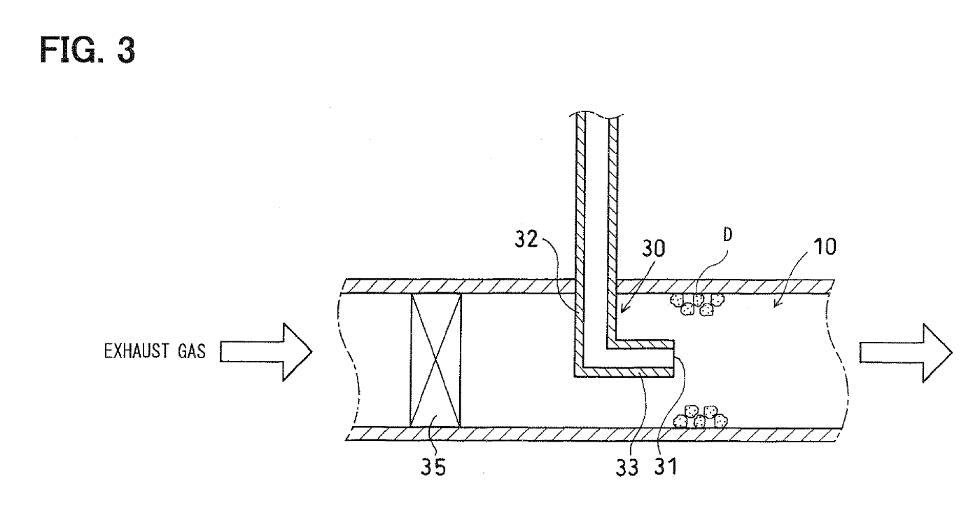

As shown in FIG. 3, an intake port 31 of a communication tube 30 is located at an approximately center position of an exhaust passage 10 in a radial direction, in a third embodiment. The center position corresponds to a center axis of the exhaust passage 10.

Further, a cyclone blade 35 is arranged at an upstream side of the tube 30 in the exhaust passage 10, and generates a swirling flow having a swirling axis corresponding to the center axis of the exhaust passage 10. The cyclone blade 35 may correspond to a swirling flow generator.

When the swirling flow is generated by the blade 35, dust D flowing in the exhaust passage 10 is flicked away toward a periphery side of the exhaust passage 10 in the radial direction, due to a centrifugal force.

Therefore, dust D can be moved away from the intake port 31 of the tube 30 located at the approximately center position of the exhaust passage 10 in the radial direction. Thus, dust D can be more effectively restricted from being drawn into the intake port 31.

Thus, dust D can be prevented from adhering onto a gas separating membrane of a separator 23, such that deterioration of the membrane can be restricted.

### Fourth Embodiment

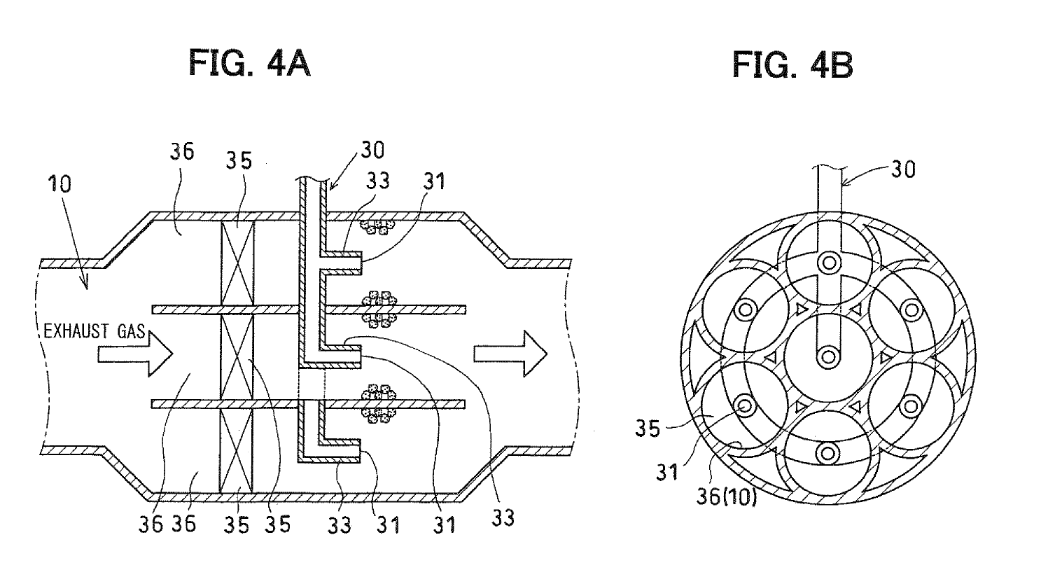

As shown in FIGS. 4A and 4B, an exhaust passage 10 is separated into plural small passages 36 extending parallel to the exhaust passage 10, in a fourth embodiment. Exhaust gas flowing through the exhaust passage 10 is distributed into the small passages 36. A communication tube 30 has plural intake ports 31, and the intake port 31 is located at an approximately center position of the small passage 36 in a radial direction. The intake port 31 is open toward a downstream side of the small passage 36.

Further, a cyclone blade 35 is located at an upstream side of the tube 30 in each of the small passages 36, so as to generate a swirling flow in each of the small passages 36.

The plural small passages 36 are arranged adjacent to each other, and extend parallel with a flowing direction of exhaust gas. Thus, a part of the exhaust passage 10 is defined by seven of the small passages 36, for example. As shown in FIG. 4B, for example, six of the small passages 36 are arranged to surround one of the small passages 36. Exhaust gas flowing in the exhaust passage 10 is distributed into the small passages 36, and the distributed exhaust gases are rejoined after passing through the small passages 36.

The communication tube 30 has parallel parts 33 and intake ports 31. The parallel part 33 is approximately parallel to an extending direction of the small passage 36. The intake port 31 is located at an approximately center position of the small passage 36 in a radial direction, and is open toward a downstream side of the small passage 36. Exhaust gas drawn through the intake ports 31 are gathered and drawn into the bypass passage 22 by the tube 30.

Further, a cyclone blade 35 is arranged at an upstream of the tube 30 in each of the small passages 36, and generates swirling flow having a swirling axis corresponding to a center axis of the small passage 36.

According to the fourth embodiment, the exhaust passage 10 is separated into the plural small passages 36, and the cyclone blades 35 are arranged in the small passages 36, respectively. Therefore, a flow speed of exhaust gas can be fast in the small passage 36, such that smaller dust can be flicked toward a periphery side of the small passage 36 in the radial direction, due to a centrifugal force. That is, the smaller dust can be restricted from being drawn into the communication tube 30.

### Fifth Embodiment

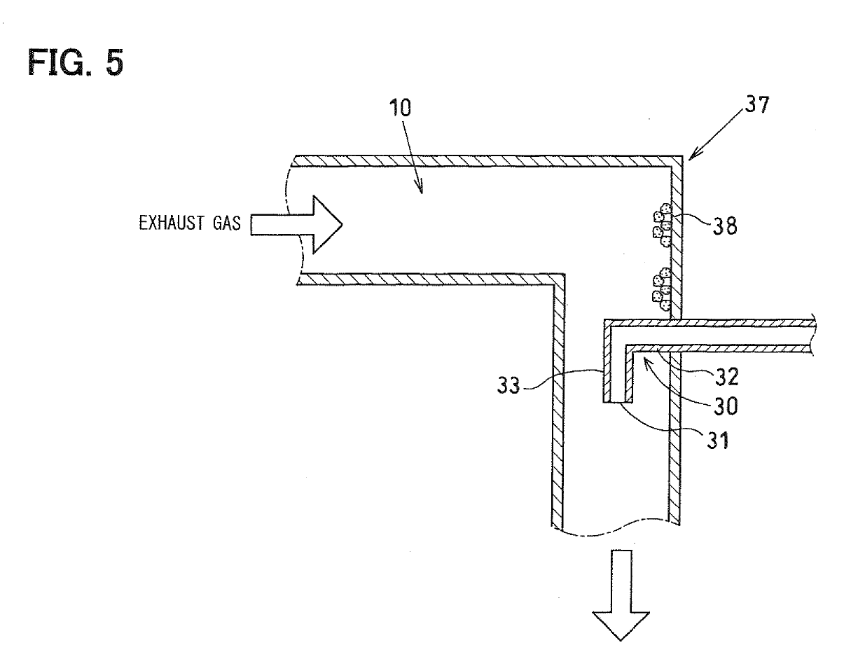

As shown in FIG. 5, a communication tube 30 is connected to a downstream side of a bent portion 37 of an exhaust passage 10, when the exhaust passage 10 has the bent portion 37, in a fifth embodiment. An intake port 31 of the tube 30 is open to a downstream side of the bent portion 37.

Dust is moved straight due to an inertia force. Therefore, as shown in FIG. 5, dust is collided with an outer wall 38 of the bent portion 37, when the exhaust passage 10 has the bent portion 37

According to the fifth embodiment, the communication tube 30 is located on the downstream side of the bent portion 37 in the exhaust passage 10. Therefore, dust can be restricted from being drawn through the intake port 31, because dust is prevented from flowing in the exhaust passage 10 by the wall 38 of the bent portion located on the upstream side of the tube 30 in the exhaust passage 10.

### Sixth Embodiment

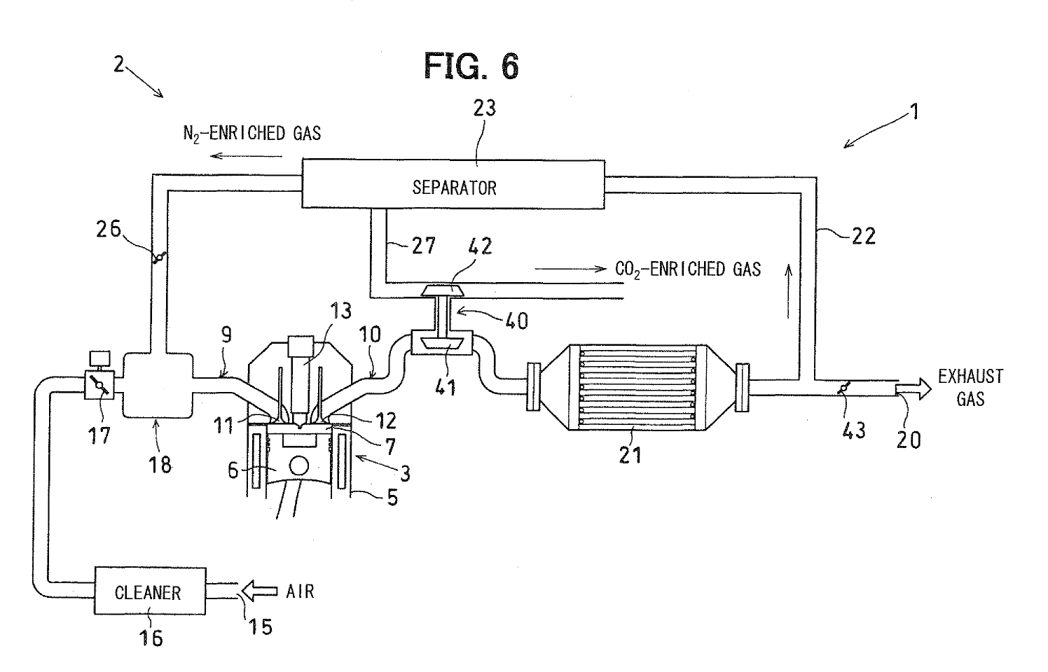

As shown in FIG. 6, a nitrogen-enriched gas supplying device 1 further includes a supercharger 40 corresponding to a negative pressure generator, in a place of the vacuum pump 28, in a sixth embodiment. The supercharger 40 includes a turbine 41 and a compressor 42. The turbine 41 is driven by energy of exhaust gas flowing in the exhaust passage 10, and the compressor 42 is driven by the turbine 41.

The turbine 41 of the supercharger 40 is located in the exhaust passage 10. The compressor 42 of the supercharger 40 is located in a pipe 27 arranged on a permeation side of a separator 23, and carbon dioxide separated by the separator 23 passes through the pipe 27.

When the turbine 41 is driven by energy of exhaust gas, the compressor 42 is driven by the turbine 41. At this time, the permeation side of the separator 23 is depressurized by the compressor 42. Thus, a negative pressure can be generated by using the energy of exhaust gas, such that efficiency can be raised.

Further, the device 1 includes a valve 43 to open or close the exhaust passage 10 at a downstream side of a branch point at which the bypass passage 22 is branched from the exhaust passage 10. When the exhaust passage 10 is closed by the valve 43, a pressure of a supply side of the gas separating membrane can be made higher.

According to the sixth embodiment, both of the valve 43 and the supercharger 40 are used as a pressure difference generator to generate a pressure difference relative to the membrane, and the pressure difference corresponds to a driving force of gas separation. Therefore, a pressure difference between the supply side and the permeation side of the membrane can be made larger.

In addition, the device 1 may further have a communication tube 30 and/or a cyclone blade 35.

### Seventh Embodiment

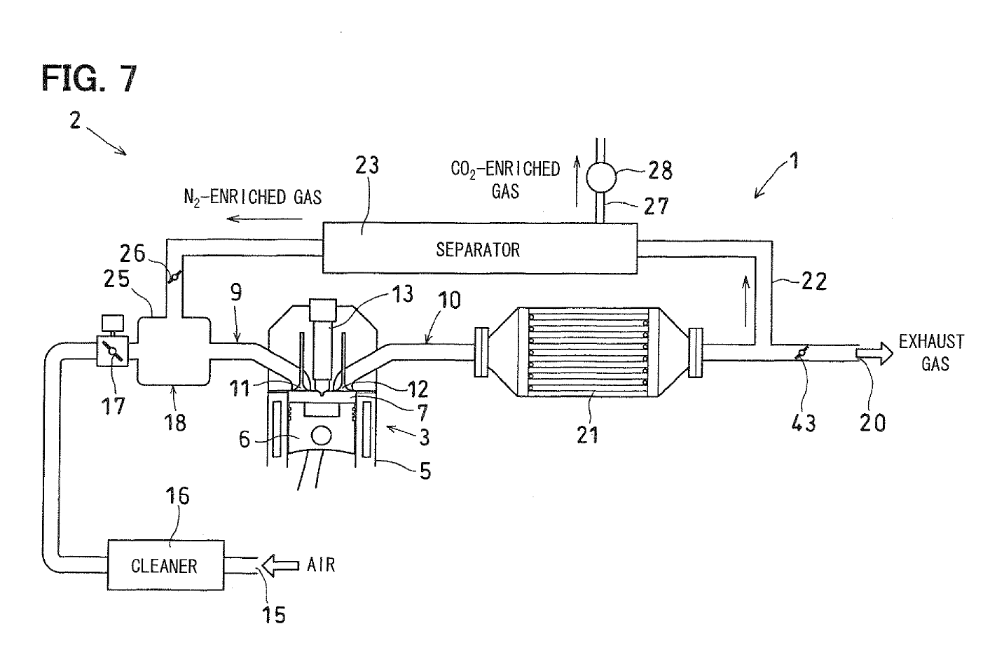

As shown in FIG. 7, a vacuum pump 28 and a valve 43 are used as a negative pressure generator to generate a pressure difference of a gas separating membrane to be a driving force of gas separation, in a seventh embodiment. The valve 43 is located at a downstream side of a branch point at which the bypass passage 22 is branched from the exhaust passage 10, and opens or closes the exhaust passage 10.

Therefore, the permeation side of the membrane is depressurized by the vacuum pump 28, and the supply side of the membrane is pressurized by the valve 43 closing the exhaust passage 10. Thus, when both of the vacuum pump 28 and the valve 43 are used, a pressure difference between the supply side and the permeation side of the membrane can be made larger.

Alternatively, the pressure difference may be generated by using only the valve 43. In this case, a buffer tank is necessary. Further, the device 1 may have a communication tube 30 and/or a cyclone blade 35.

### Other Embodiment

The gas separating membrane is made of the hollow fibers, such that a size of the membrane can be made smaller. Alternatively, the membrane may have a spiral shape, a tube shape, or a flat film shape.

Such changes and modifications are to be understood as being within the scope of the present invention as defined by the appended claims.

What is claimed is:

1. A nitrogen-enriched gas supplying device for an internal combustion engine, the device comprising:
a bypass passage to introduce a part of exhaust gas from an exhaust passage of the engine into an intake passage of the engine; and
a gas separating membrane arranged in the bypass passage, wherein
the gas separating membrane is configured to separate carbon dioxide from exhaust gas introduced into the bypass passage.

2. The nitrogen-enriched gas supplying device according to claim 1, further comprising:
a negative pressure generator to generate a pressure difference between a supply side and a permeation side of the gas separating membrane, wherein
the negative pressure generator is arranged on the permeation side of the gas separating membrane.

3. The nitrogen-enriched gas supplying device according to claim 1, wherein
the bypass passage has a L-shaped communication tube having an intake port open toward a downstream side of the exhaust passage, and
the bypass passage is connected to the exhaust passage through the communication tube.

4. The nitrogen-enriched gas supplying device according to claim 3, further comprising:
a swirl flow generator to generate a swirl flow in the exhaust passage, wherein
the swirl flow generator is located on an upstream side of the communication tube in the exhaust passage, and
the intake port of the communication tube is located at an approximately center position of the exhaust passage in a radial direction.

5. The nitrogen-enriched gas supplying device according to claim 3, further comprising:
a plurality of swirl flow generators to generate swirl flow, wherein
the exhaust passage has a plurality of small passages separated to extend approximately parallel to a flowing direction of exhaust gas, such that exhaust gas is distributed into the plurality of small passages,
the intake port of the communication tube is open toward a downstream side of each of the small passages,
the intake port of the communication tube is located at an approximately center position of each of the small passages in a radial direction, and
the swirl flow generator is located on an upstream side of the communication tube in each of the small passages.

6. The nitrogen-enriched gas supplying device according to claim 3, wherein
the exhaust passage has a bent portion, and
the communication tube is connected to a downstream side of the bent portion in the exhaust passage.

7. The nitrogen-enriched gas supplying device according to claim 2 wherein
the negative pressure generator is a supercharger, and the supercharger having
a turbine to be driven by energy of exhaust gas flowing through the exhaust passage, and
a compressor to be driven by the turbine.

8. The nitrogen-enriched gas supplying device according to claim 1, further comprising:
a valve to open or close the exhaust passage, wherein
the bypass passage is branched from the exhaust passage at a branch point, and
the valve is located on a downstream side of the branch point in the exhaust passage.
